(19) United States
(12) Patent Application Publication
(10) Pub. No.: US 2004/0250128 A1
(43) Pub. Date: Dec. 9, 2004

(54) System and method for network security analysis

(76) Inventors: Stephen F. Bush, Latham, NY (US); Scott C. Evans, Burnt Hills, NY (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/453,204

(22) Filed: Jun. 3, 2003

(51) Int. Cl. G06F 11/30

(52) U.S. Cl. 713/201

(57) ABSTRACT

A system and method for network security analysis are provided, wherein points of high vulnerability in the network may be identified by evaluating the complexity of data in the network. Points of low complexity are determined to be highly vulnerable, while points of high complexity are determined to be less vulnerable.

### FIELD OF INVENTION

The present invention relates to evaluating security of networks, and more particularly, to evaluating security of ad-hoc wireless networks.

### BACKGROUND OF THE INVENTION

Identifying weaknesses in computer networks is important to assuring security and validity of information. The security of a computer network may be comprised using many different types of attacks on the computer network. Often such attacks are not identified until long after they have occurred, when extreme damage has already been done. Often, vulnerabilities in a computer network are analyzed by maintaining a database of known attacks. Information regarding an attack may be stored in the database and used to identify and prevent future similar attacks. However, this method of defense is ineffective as it may only be updated with new attacks after the network has already been compromised and the attack analyzed. Such defenses are only reactive and may leave a computer network highly vulnerable. It is desirable to have a proactive method of defense, where an attack can be prevented before the computer network is compromised.

### SUMMARY OF INVENTION

In one aspect of the invention, a method of evaluating vulnerability in a computer network is provided. The method comprises acts of a) receiving data related to an ad-hoc wireless network, b) performing complexity analysis on the data, and c) determining the vulnerability of the network based, at least in part on the complexity analysis of the data.

In one embodiment, the method the act b) further comprises an act of estimating a Kolmogorov complexity of the data. The method may also comprise an act of estimating the Kolmogorov complexity of the data using a universal compression algorithm. The method also comprise an act of estimating the Kolmogorov complexity of the data using pseudorandom number analysis.

In one embodiment, the method may include an act of computing a plurality of complexity values based on the Kolmogorov complexity of the data and a length of the data. A Kolmogorov Complexity Map may be generated, based on the plurality of complexity values.

In another embodiment, the act a) further comprises an act of receiving data that includes at least one routing table of a plurality of nodes in the ad-hoc wireless network. The act a) may also include an act of receiving data that includes information relating to movement patterns of at least one wireless node in the ad-hoc wireless network. The act a) may further include an act of receiving data that includes information relating to a routing protocol of the at least one wireless network.

In another embodiment, the act c) further comprises an act of determining the ad-hoc wireless network to have high vulnerability if the data has low complexity.

In another aspect of the invention, an apparatus is provided. The apparatus comprises: a) at least one complexity estimator adapted to receive data relating to an ad-hoc wireless network and generate complexity estimates of the data and b) an analyzer adapted to analyze points of vulnerability in the ad-hoc wireless network based on the complexity estimates.

In one embodiment, the at least one complexity estimator is further adapted to generate complexity estimates based on a Kolmogorov complexity of the data. The analyzer may be further adapted to generate a K-Map of the ad-hoc wireless network based on the complexity estimates.

In one embodiment, the data relating to the ad-hoc wireless network includes data relating to a routing table of a host in the ad-hoc wireless network. The data relating to the ad-hoc wireless network may also include data relating to a routing protocol of the ad-hoc wireless network. The data relating to the ad-hoc wireless network includes data relating to movement patterns of at least one wireless node in the ad-hoc wireless network.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram of components in a computer system according to one embodiment of the invention;

FIG. 2 is an example of a K-Map for the computer system of FIG. 1, according to one embodiment of the invention;

FIG. 3 is a directed graph representing complexity costs between nodes in a computer network, according to one embodiment of the invention;

FIG. 4 is a matrix showing the minimum complexity paths of the graph of FIG. 3, according to one embodiment of the invention;

FIG. 5 is a contour map showing an example of a complexity surface for the graph of FIG. 3, according to one embodiment of the invention;

FIG. 6 is a contour map showing an example of insecurity flow for the graph of FIG. 3, according to one embodiment of the invention;

FIG. 7 is a diagram of an example of wireless users in an ad-hoc wireless network, according to one embodiment of the invention; and

FIG. 8 is a diagram of an ad-hoc wireless network according to one embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

System security may be analyzed in the context of a universal computer. A universal computer is a computer that, given a description of any other computer, can perfectly emulate that computer. One example of a universal computer is a Universal Turing machine.

The transition function δ of a Turing machine describes how the machine gets from one step to the next. The function δ can be defined as: Q×Γ→Q×Γ×{L, R}. That is, for example, when the machine is in a certain state q and the head is over a tape square containing a symbol a, and δ(q,a)=(r, b, L), then the machine writes the symbol b replacing the a and goes to state r. The L indicates that that the tape head moves to the left after writing. A Turing machine can be formally defined by the Tuple (Q,Σ,Γ,δ,qₒ,q_{accept},q_{reject}), where Q is the finite set of states, Σis the input alphabet of the machine, Γ is the tape alphabet, δ is the transition function, qₒ is the start state, q_{accept} is the accept state, and q_{reject} is the reject state.

System security may be analyzed by considering a Turing machine program as a representation of normal system operation. For example, if the Turing machine recognizes a particular string, then a user has gained access to the system. A system may be determined to be vulnerable if the Turing machine recognizes a string that was not anticipated. Assuming that an attacker, desiring to exploit a vulnerability, has the ability to view every input string and its corresponding output, the attacker may use this information to infer the transition function δ. Once δ is known, an attacker may easily gain access to the system by creating a string that he knows will be accepted by the machine. Thus, the Turing machine acts as an abstract representation of a protocol implementation or operating component operation.

Generally, it is desirable to allow access to legitimate users while denying access to potential attackers. One way of accomplishing this is by increasing the complexity of the access to the information while providing legitimate users with enough a priori knowledge to reduce the apparent complexity. One example of a method for increasing the complexity of access to information is the use of cryptographic ciphers. For example, information may be stored in plain text on a system, allowing any user to view the information. By encrypting the information, the complexity of accessing the information has been increased, as now one must decrypt the information before viewing it. Thus, only those users with the a priori knowledge of the proper decryption keys and those “attackers” who are able to guess or compute those keys may access the information. The complexity of accessing the information may further be increased, for example, by increasing the length of the keys (depending on the encryption algorithm being used) or adding additional layers of encryption.

As a result, it is logical to conclude that complexity of access to data is useful in measuring system security. However, finding an absolute measure of complexity that can be applied to all systems regardless of the details of the system (e.g., operating system, protocols used, etc.) may difficult. One measure of complexity is Kolinogorov Complexity. Kolmogorov Complexity is a measure of the descriptive complexity contained in an object or string. It refers to the minimum length of a program such that a universal computer can generate a specific string. Any given string has a Kolmogorov Complexity, without regard to the details of the system on which it is running. The operating system, protocol being used, and meaning of the data represented by a particular string, while related to string complexity, need not be known in order to measure the string complexity. Because Kolmogorov Complexity is an inherent property of a string, it can be used as a baseline in evaluating many different types of data.

Kolmogorov Complexity K(x) of a string x, using a Turing Machine φ, where p represents a program and l(p) represents the length of program p can be described by the equation of Table 1.

TABLE 1
${K}_{ϕ} ( x ) = \{ {min}_{ϕ ( p ) = x} l ( p ) \}$

Conditional Complexity, illustrated by the equation in Table 2, quantifies the complexity of a string x relative to that of a string y. That is, Conditional Complexity is the complexity of a string x beyond that in stringy. If a stringy cannot be computed given the string x (i.e., if the operation does not use x as an input to generate y) the Conditional Complexity is infinite.

TABLE 2
${K}_{ϕ} ( y \vert x ) = \{ \begin{matrix}{min}_{ϕ ( p , x ) = y} l ( p ) \\ ∞ , if ∀ p , ϕ ( p , x ) \neq y\end{matrix} \}$

One problem that arises when determining the Kolmogorov Complexity of a string is that there are many different types of universal computers and the Kolmogorov Complexity of the same string may be different on different universal computers. However, the Kolmogorov Complexity of the same string, x, on different universal computers will differ at most by an additive constant. However, the major difficulty with Kolmogorov Complexity is that it is not computable. The length of any program that produces a given string is an upper bound on the Kolmogorov Complexity for that string, but the lower bound cannot be computed.

Various methods of estimating Kolinogorov Complexity are available. An example of a method for estimation of Kolmogorov Complexity is using a universal compression algorithm, such as LZ77 or LZ78. Other method of estimating complexity are also available for example using Huffman coding techniques or pseudo-random number analysis techniques. It should be appreciated that many other techniques for estimating Kolmogorov Complexity are available and are contemplated to be within the spirit and scope of the present invention.

The density of a string or object is another metric, based on Kolmogorov Complexity, which is useful in vulnerability analysis. As shown in Table 3, the density, d, of a string, x, may be defined as the Kolmogorov Complexity of the string K(x), divided by the length of the string, l(x).

TABLE 3
$d = \frac{K ( x )}{l ( x )}$

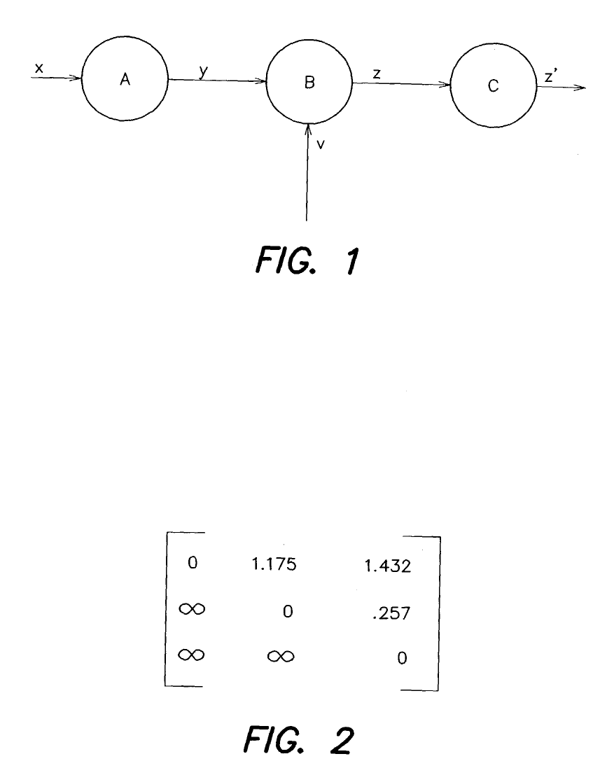

The inverse of density is dispersion. If x represents a program, then dispersion may be considered inefficiency in implementation of the program in terms of size, as the disperse implementation has more transitions and states than necessary. These additional transitions and states introduce additional potential points of vulnerability that an attacker may exploit. For example, referring to FIG. 1, suppose operation A, is an algorithm which generates keys for use in encryption and decryption. Operation A takes as input a string x which represents a user ID number and generates as an output an decryption key, represented by the stringy. Further, suppose Operation B is a block cipher which takes the stringy as input and applies it to encrypted data, represented by the string v to generate plain text data, represented by the string z. If the stringy has a relatively high Kolmogorov Complexity, yet also is relatively long, then the string will have a relatively low density (i.e., relatively high dispersion). The high density of y may make it easier for an attacker to infer the transition function, δ, of operation B, because the relatively large amount of information in stringy (i.e., due to its length) may aid an attacker in inferring the function which generates z. Thus, if operation A is compromised by an attacker, the relatively low density of stringy may make it easier for an attacker to comprise operation B. Thus, density represents the ease of movement of an attacker from one point of vulnerability to another.

Continuing in the example above, suppose the system illustrated in FIG. 1 also includes an operation C, which represents a text-editor that takes as an input string z and generates an edited plain text string z′ which it saves on the system. Assume that z, being in plain text form, has a relatively low Kolmogorov Complexity and a relatively high length, thus yielding a low density. Again, the low density of string z increases the likelihood that an attacker may infer the transition function, (δ, of operation C, allowing the attacker to save data to the system. As can be seen, a relatively high Kolmogorov Complexity at operation A may actually increase the vulnerability of the overall system, due to the low density output of the operation.

Generally, information systems, such as computer systems, take some form of data as input, process the data, and return some data as output. Thus, an information system can typically be defined as a mathematical operation. Usually, information systems include a hierarchy of functional units and have well-defined data flows and processing functions. In such systems, a complexity estimator may be may be placed at the inputs and outputs of these functional units, allowing for determination of the vulnerability of each process in the data stream. In this way, a complexity-based vulnerability map of the system may be generated. Because a potential attacker would most likely not have access to the information at the level of detail provided by all the complexity estimators, complexity estimators may be placed only at the inputs or outputs of the functional units likely to be observable by an attacker.

As mentioned above, a Kolmogorov Complexity Map, hereinafter referred to as a K-Map, may be generated based on information generated by the complexity estimators. The K-Map includes a c x c→\hat{K}/L matrix, where c is the set of information components, or functional units. Thus, the matrix represents the density values of possible points of attack crossed with target components. The information components may represent any logical unit in the system, depending on the desired level of granularity. For example, information components may represent a host within the network. Additionally, if a finer level of granularity is desired, information components could represent, for example, a process running on a single host. At an even finer level of granularity, information components could represent different parts of a single process or software application, such as software modules or software objects.

An example of a K-Map is illustrated in FIG. 2. The K-Map of FIG. 2 is a matrix of the information components, c, shown in FIG. 1. Components that cannot be physically accessed from eat other have an infinite complexity value. For example, because component A cannot be reached from component B, the value at row 2, column 1 of the matrix is infinity. The diagonal values of the matrix are zero because the complexity of the component, assuming that the component has already been compromised is zero. The values of the K-Map change as an attack progresses, because the complexity of one string may change as a result of the attacker gaining information about another string. The complexity values may be updated using the Conditional Complexity estimates according to the equation of Table 2. These estimates may be used in the density metric of Table 3 to determine the complexity values of the matrix.

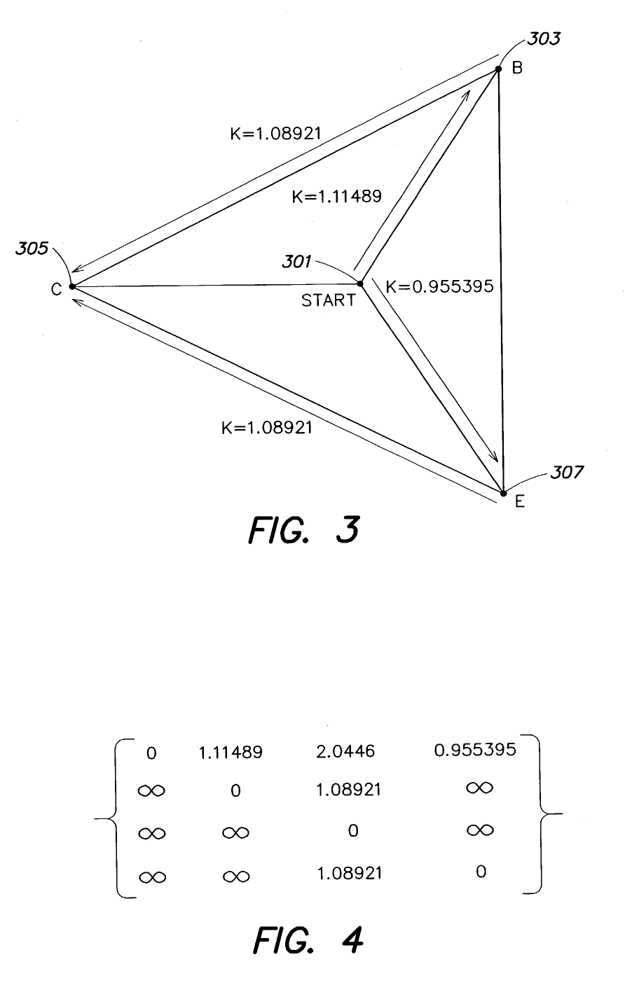

Using the complexity estimates which are used to generate the complexity values of the K-Map, a directed graph (“digraph”) may be created. For example, in FIG. 3, a directed graph is created for a network having three nodes: node B 303, node C 305, and node E 307. Start node 301 represents a location outside of the network. An arrow between two nodes indicates that data may flow between two nodes in the direction of the arrow. For example, the arrow between start node 301 and node B 303 indicates that node B 303 is an entry point of the network because data can flow to it from a location outside of the network (i.e., start node 301). Simialrly, node E 307 is an entry point of the network, as it also may be reached from start node 301. By contrast, node C 305 may not be reached from start node 301, but may be reached from both node B 303 and node E 307.

The numerical values shown between nodes represent Kolmogorov complexity estimates of data traveling between the two nodes. For example, the value 1.08921 is a complexity estinate of data traveling from node B 303 to Node C 305. These complexity estimates may be an average of the complexity estimates of all distinct strings observed traveling between the two nodes (e.g., packets) or may be the complexity of all data observed traveling between the two nodes (e.g., all observed packets). The complexity estimate may also be an estimate of a single packet traveling between the two nodes. If there is no path between two nodes, then the complexity of data traveling between the two nodes can be thought of as infinity. For example, the complexity of traveling from node C 305 to node E 307 is infinity because there is no path in the graph from node C 305 to node E 307. The complexity of data traveling from a node to itself can be thought of as zero, as the data is already at the node.

Based on the complexity estimates in the directed graph, a matrix may be generated which shows the minimum cost, in terms of complexity, of reaching any node in the network from any other node in the network. Such a matrix for the directed graph of FIG. 3 is illustrated in FIG. 4. In FIG. 4, each row represents a node in the network from which data originates. Thus, the first row represents data originating from start node 301. The second row represents data originating from node B 303. The third row represents data originating from node C 305. The fourth row represents data originating from node E 307. Each column represents a destination node for the data in the network. Thus, the first column represents data having a destination node of start node 301. The second column represents data having a destination node of node B 303. The third column represents data having a destination node of node C 305. The fourth column represents data having a destination node of node E 307.

The minimum complexity of data traveling from any node in the network to any node in the network may be determined by looking at the appropriate row and column location in the matrix. For example, to determine the complexity of traveling from start node 301 to node C 305, one would look to the first row and third column in the matrix, which shows that the minimum cost, in terms of complexity, is 2.0446. Referring back to the directed graph of FIG. 3, one can see that the minimum cost of reaching node C 305 from start node 301 is by first traveling from start node 301 to node E 307 at a complexity cost of 0.955395 and then traveling from node E 307 to node C 305 at an additional complexity cost of 1.08921, for a sum of 2.0446. The minimum complexity cost values of the matrix of FIG. 4 may be calculated in many different ways, for example using well know shortest-path algorithms.

Maximum flow analysis may also be performed on the graph of FIG. 3 using the complexity estimates to determine the maximum flow through each link. A complexity surface may then be generated showing the resulting flows. Higher areas correspond to less vulnerable components while lower areas correspond to more vulnerable components. Areas of infinite height are shown without a surface. Thus, the start node is an infinitely high mountain in the center of the map, as it cannot be attacked from any other node. Node E is the most vulnerable node and is in the lowest area of the contour map. While Node C cannot be directly attacked from the start node, it can be attacked via nodes B and E

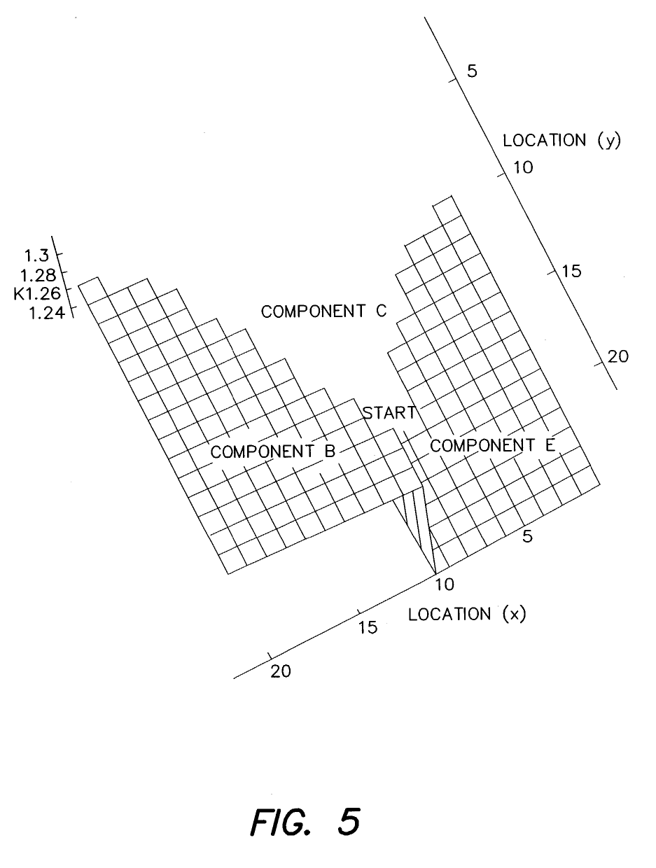

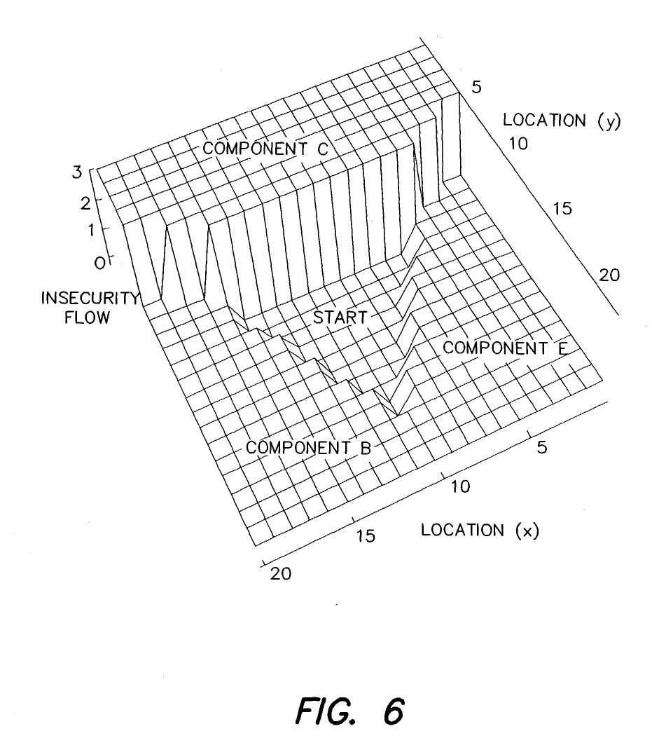

An insecurity flow contour map may also be generated by summing all possible flows from and to every node. An example of insecurity flow contour map tor the graph of FIG. 3 is illustrated in FIG. 6. While Node C has infinite complexity (as shown in FIG. 5) because it cannot be reached directly from the start node, it is actually the most insecure node, because there are two separate paths of attacking node C (i.e., through either node B or node E).

As mentioned above, computer networks are susceptible to many different types of attacks. Additional problems of security are introduced when dealing with ad-hoc wireless computer networks. An ad-hoc wireless network is a collection of mobile hosts forming a temporary network without the use of any centralized administration. For example, suppose several friends carrying laptop computers meet randomly in a coffee shop and wish to share data stored on their laptops. Requiring these friends to connect to a wide area network simply to share data with each other may be impossible due to lack of available network infrastructure (i.e., network hardware and software) or impractical due to the time and effort necessary to make such a connection. Such a network may also have military applications, for example, when several military vehicles or aircraft wish to communicate with each other while in the field. The scenarios above describing the use of ad-hoc wireless networks are given only by way of example and are not intended to be limiting. There are many other situations in which the use of wireless ad-hoc networks is applicable and these are intended to be within the spirit and scope of the invention.

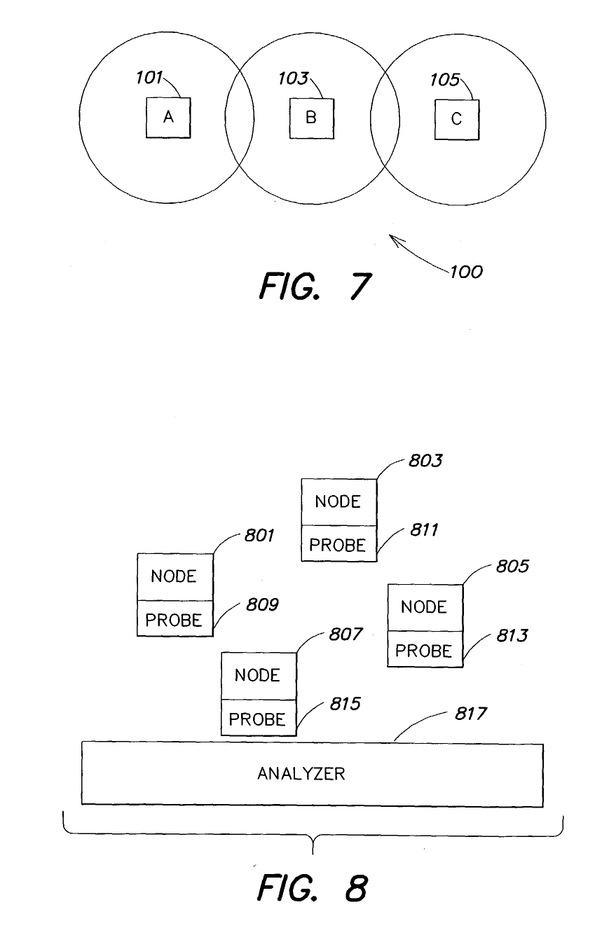

FIG. 7 illustrates a simple ad-hoc network 100 with three wireless hosts 101, 103 and 105. The circle around each hosts illustrates the range of its wireless transmitter. FIG. 7 illustrates some of the problems involved in forming a wireless network and some of the additional points of network vulnerability that are introduced. In FIG. 7, host C 105 is out ofthe range ofthe wireless transmitter of host A 101. Thus, for host C 105 and host A 101 to be able to communicate with each other, they must rely on host B 103 to propagate network communications between the two. In a sense, each host 101, 103, and 105 may be thought of as a router which maintains a routing table of with which wireless nodes it can communicate directly and which wireless nodes can be used to communicate with the wireless nodes that cannot be reached directly. Maintaining such a routing table is complicated by the fact that wireless nodes may be constantly moving and may also be entering and leaving the network suddenly. There are well known routing protocols designed for use in ad-hoc wireless networks. It should be appreciated that the present invention is not limited to any specific routing protocol.

In addition to being susceptible to attacks to which a conventional computer network is susceptible, such as distributed denial of service attacks, buffer overflow attacks, and the like, ad-hoc wireless networks are particularly susceptible to eavesdropping attacks, data modification attacks, and impersonation attacks. Because wireless nodes may enter and leave the network rapidly, it is possible for an attacker to enter the network pretending to be someone else. The attacker may then intercept sensitive data or otherwise compromise the network, such as by broadcasting fake routing information. Also, because data is transmitted wirelessly, the data may be more susceptible to eavesdroppers. It should be appreciated that the above-described attacks on computer networks are given only as examples. Many other types of attacks on computer networks exist. For example, the routing protocol itself may be a point of vulnerability for an ad-hoc wireless networks. Because routing protocols for ad-hoc networks are typically designed for scenarios where nodes are rapidly entering and leaving the network and may be constantly moving, they may be more vulnerable to impersonation attacks or other types of attacks than the routing protocol of a conventional network. Further, because nodes in a wireless ad-hoc network have the ability to move, patterns of movement of nodes may be another point of vulnerability in an ad-hoc wireless network.

Like conventional networks, it is even more desirable to deal with malicious attacks on an ad-hoc wireless network in a proactive, rather than a reactive manner. This is because an ad-hoc wireless network may exist for only a short period of time, relative to that of a conventional network, and recording a signature of an attack would serve no purpose. Further, because the structure of an ad-hoc wireless network may change rapidly, due to the movement of nodes, the signature of the same attack may be different if the structure of the ad-hoc wireless network has changed.

Thus, evaluating the complexity at potential points of vulnerability may allow one to determine where an attack is likely to occur. FIG. 8 is a diagram illustrating an example of an ad-hoc wireless network, according to one embodiment of the invention. The ad-hoc wireless network includes a plurality of nodes 801, 803, 805, and 807. In the example of FIG. 8 four network nodes are shown, however it should be appreciated that the ad-hoc network may include many more nodes. The nodes may be for example, hosts in the network, such as individual users computers, or may be other networked devices, such as printers, scanners, and the like.

The network may include a plurality of complexity probes 809, 811, 813, and 815. As shown in FIG. 8, each complexity probe may be associated with a particular node and monitor data transferred to and from its respective node. Alternatively, complexity probes may be located only at selected locations in the network.

The complexity probes may monitor various types of data. For example, the complexity probes may estimate complexity for all data entering or leaving a node. Alternatively, the complexity probes may only estimate complexity for data associated with a particular application. For example, if it were desired to evaluate the vulnerability of an e-mail client application, such as sendmail, then the complexity of data associated with that application may be estimated.

Several types of data which may be points of points of vulnerability particularly in ad-hoc wireless networks may also be monitored. As mentioned above, because nodes in an ad-hoc wireless network have the ability to move, the rerouting tables of nodes may change relatively frequently By compromising the routing table of a node, an attacker may gain access to the network through impersonation or eavesdropping, as well as simply making the network un-operational. Thus, the complexity of the routing tables of the nodes in the network may be estinated by the complexity probes to evaluate their vulnerability. Alternatively, the complexity routing protocol itself may be estimated by the complexity probes. For example, the complexity all network messages relating to the routing protocol may be estimated. Other methods of estimating the complexity of the routing protocol will readily occur to those skilled in the art and intended to be within the spirit and scope of the invention.

Another point of vulnerability in ad-hoc wireless networks is the movement patterns of nodes in the network. For example, if the movement patterns of the nodes in the network are regular, the network may be susceptible to impersonation, eavesdropping, or other types of attacks. Such a situation may occur when, for example, aircraft or land vehicles travel in regular paths, such as on military training missions. The movement patterns of nodes may be tracked in various ways. One such way is to include a global positioning satellite (GPS) receiver in each complexity probe, or alternatively, in each node. The complexity of the GPS coordinates of nodes may then be estimated.

Analyzer 817 uses the complexity estimates generated by the complexity probes to determine potential points of vulnerability of the network. For example, analyzer 817 may be used to generate a K-Map, a topological complexity contour may, or an insecurity flow contour map, as described above.

Analyzer 817 may be implemented as either hardware, software, or a combination thereof. Additionally, analyzer 817 may be an offline tool which collects data from the complexity probes, after dissolution of the network. Alternatively, the complexity probes may transmit complexity estimates to analyzer 817 as data is processed (i.e., during operation of the ad-hoc network). Also, instead of being a central analyzer, analyzer 817 may distributed across the nodes in the network. That is, for example, the nodes in the network themselves may perform all or part of the vulnerability analysis of the network. Many other ways of implementing analyzer 817 are possible and contemplated to be within the scope of the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of evaluating vulnerability in a computer network, comprising acts of:
a) receiving data related to an ad-hoc wireless network;
b) performing complexity analysis on the data; and
c) determining the vulnerability of the network based, at least in part, on the complexity analysis of the data.

2. The method of claim 1, wherein the act b) further comprises an act of estimating a Kolmogorov complexity of the data.

3. The method of claim 2, further comprising an act of estimating the Kolmogorov complexity of the data using a lossless compression algorithm.

4. The method of claim 2, further comprising an act of estimating the Kolmogorov complexity of the data using pseudorandom number analysis.

5. The method of claim 2, further comprising an act of computing a plurality of complexity values based on the Kolmogorov complexity of the data and a length of the data.

6. The method of claim 5, further comprising an act of generating a Kolmogorov Complexity Map, based on the plurality of complexity values.

7. The method of claim 1, wherein the act a) further comprises an act of receiving data that includes at least one routing table of a plurality of nodes in the ad-hoc wireless network.

8. The method of claim 1, wherein the act a) further comprises an act of receiving data that includes information relating to movement patterns of at least one wireless node in the ad-hoc wireless network.

9. The method of claim 1, wherein the act a) further comprises an act of receiving data that includes information relating to a routing protocol of the at least one wireless network.

10. The method of claim 1, wherein the act c) further comprises an act of determining the ad-hoc wireless network to have high vulnerability if the data has low complexity.

11. An apparatus comprising:
a) at least one complexity estimator adapted to receive data relating to an ad-hoc wireless network and generate complexity estimates of the data; and
b) an analyzer adapted to analyze points of vulnerability in the ad-hoc wireless network based on the complexity estimates.

12. The apparatus of claim 11, wherein the at least one complexity estimator is further adapted to generate complexity estimates based on a Kolmogorov complexity of the data.

13. The apparatus of claim 12, wherein the analyze is further adapted to generate a K-Map of the ad-hoc wireless network based on the complexity estimates.

14. The apparatus of claim 11, wherein the data relating to the ad-hoc wireless network includes data relating to a routing table of a host in the ad-hoc wireless network.

15. The apparatus of claim 11, wherein the data relating to the ad-hoc wireless network includes data relating to a routing protocol of the ad-hoc wireless network.

16. The apparatus of claim 11, wherein the data relating to the ad-hoc wireless network includes data relating to movement patterns of at least one wireless node in the ad-hoc wireless network.
